(19) United States
(12) Patent Application Publication
(10) Pub. No.: US 2002/0117049 A1
(43) Pub. Date: Aug. 29, 2002

(54) Pneumatic motor

(76) Inventor: Ta-Chin Wang, Tainan (TW)

Correspondence Address: Jones, Tullar & Cooper, P.C., Suite 1002, 2001 Jefferson Davis Highway, Arlington, VA, 22202, US

(21) Appl. No.: 09/791,620

(22) Filed: Feb. 26, 2001

(51) Int. Cl. F15B 11/08

(52) U.S. Cl. 91/422; 92/84

(57) ABSTRACT

A pneumatic motor includes a cylinder and a piston movably received in the cylinder. The cylinder includes a first end cover and a second end cover respectively attached to the opposite ends of the cylinder. An inlet port is defined in the first end cover and an outlet port is defined in the second end cover. The piston divides the cylinder into two chambers. An exhaust passage is defined in the piston and communicates with the two chambers. A cavity is defined in the first end cover to receive a shock absorber, and a path is defined to communicate with the cavity and the inlet port in the first end cover. The shock absorber mounted in the cavity in the first end cover cushions the striking force when the piston strikes the first end cover.

### BACKGROUND OF THE INVENTION

1. Field of the Invention

The present invention relates to a pneumatic motor, and more particularly to a pneumatic motor that can replace the lever of a hydraulic jack for pumping hydraulic fluid into the jack.

2. Description of Related Art

With reference to FIGS. 3 and 4, a conventional pneumatic motor in accordance with the prior art comprises a cylinder (50), a piston (51) movably received in the cylinder (50), a drive rod (52) attached to the piston (51) and a spring (53) mounted in the cylinder (50) to provide a restitution force on the piston (51).

The cylinder (50) includes a first end cover (501) and a second end cover (503) respectively mounted in opposite ends of the cylinder (50) to close the cylinder (50). The first end cover (501) has an inlet port (502) defined to connect to a compressed air source, and the second end cover (503) has an outlet port (504) defined to exhaust the air in the cylinder (50). An annular recess (505) is defined in the internal periphery of the cylinder (50) and near the middle portion of the cylinder (50).

The piston (51) divides the cylinder (50) into a first chamber communicating with the inlet port (502) and a second chamber communicating with the outlet port (504). Two seals (511) are respectively mounted around the opposite ends of the piston (51) and abut the internal periphery of the cylinder (50). A passage (512) is defined radially in the piston (51) between the two seals (511). A cylindrical cavity (513) is defined in the piston (51) and communicates with the passage (512) and the first chamber of the cylinder (50). An exhaust passage (514) is defined in the piston (51) and communicates with the second chamber of the cylinder (50). A path (515) is defined in the piston (51) between the exhaust passage (514) of the piston (51) and the first chamber of the cylinder (50).

An actuating piston (60) is movably received in the cylindrical cavity (513) and has a rod (61) extending into the first chamber of the cylinder (50). The rod (61) has a neck (611) formed near the actuating piston (60) and received in the path (515) in the piston (51). A stopper (516) is secured on the end of the piston (51) to prevent the actuating piston (60) from detaching from the piston (51). A valve disk (62) is mounted on the free end of the rod (61) to selectively close the path (515) between the exhaust passage (514) and the first chamber of the cylinder (50).

A collar (55) is mounted in the second end cover (503) of the cylinder (50). A nipple (56) is mounted in the collar (55) and has a through hole (561) defined to allow the drive rod (52) to move inside the through hole (561). The nipple (56) is adapted to connect to a hydraulic source, and the pneumatic motor is the prime mover to pump hydraulic into a jack when the drive rod (52) moves back and forth in the nipple (56). A spring (53) is compressively mounted around the drive rod (52) between the piston (51) and the second end cover (503) to provide a restitution force to the drive rod (52) such that the piston (51) abuts the first end cover (501) before the pneumatic motor is in operation.

In operation, compressed air is injected into the first chamber via the inlet port (502) to push the piston (51) toward the second end cover (503) to compress press the spring (53) and press the valve disk (62) to close the path (515). When the piston (51) moves to the position where the seal (511) on the inlet end of the piston (51) is in the recess (505), the compressed air flows into the cylindrical cavity (513) in the piston (51) via the recess (505) and the passage (512) to push the actuating piston (60) and the valve disk (62) moves toward the first end cover (501) to open the path (515). Accordingly, the compressed air in the first chamber will directly flow into the second chamber via the path (515) and the exhaust passage (514), and the pushing force providing by the compressed air on the piston (51) will reduce. The tension in the compressed spring (53) moves the piston (51) back toward the first end cover (501) and the drive rod (52) moves outward relative to the open end of the through hole (561) in the nipple (56). When the valve disk (62) strikes the first end cover (501), the valve disk (62) is pushed toward the piston (51) and closes the path (515) between the first chamber and the exhaust passage (514). Consequently, the compressed air pushes the piston (51) toward the second end cover (503) again.

A suction force will be applied to the hydraulic source as the drive rod (52) moved toward the first end cover (501), and a compression force will be applied to the hydraulic fluid in the through hole (561) as the drive rod (52) moves toward the second end cover (503). With the appropriate use of a series of check valves, the hydraulic fluid can be transmitted to a hydraulic device such as a power repairing kit, a hoisting jack, a hydraulic cylinder, a hydraulic jack or the like.

However, the conventional pneumatic motor has the following disadvantages:

1. Excessive noise and shock occur when the compressed air is exhausted through the exhaust passage (514).

2. Excessive noise occurs when the valve disk (62) strikes the first end cover (501).

3. Dust easily enters the cylinder (50) through the outlet port (504) as the piston (51) returns to its rest position so that the inner elements of the pneumatic motor are easily worn out. The useful life of the pneumatic motor is shortened.

The present invention has arisen to mitigate and/or obviate the disadvantages of the conventional pneumatic motor.

### SUMMARY OF THE INVENTION

The main objective of the present invention is to provide an improved pneumatic motor that can reduce the noise generated by the pneumatic motor. The pneumatic motor comprises a cylinder and a piston movably received in the cylinder. The cylinder includes a first end cover and a second end cover respectively attached to opposite ends of the cylinder. An inlet port is defined in the first end cover and an outlet port is defined in the second end cover. The piston divides the cylinder into a first chamber communicating with the inlet port and a second chamber communicating with the outlet port. An exhaust passage is defined in the piston and communicates with the first chamber and the second chamber. A noise silencer covers the exhaust passage. A cavity is defined in the first end cover to receive a shock absorber, and a path is defined between the cavity and the inlet port in the first end cover. With such a configuration and use of a noise silencer, noise will not occur when the air exhausts from the cylinder. Furthermore, the shock absorber mounted in the cavity of the first end cover can cushion the striking force rather than have the piston directly strike the first end cover.

The secondary objective of the invention is to provide an improved pneumatic motor wherein an exhaust valve is mounted in the outlet port. Consequently, dust cannot enter the cylinder. Wear of the inner elements can be significantly reduced, and the useful life of the pneumatic motor is prolonged.

Further benefits and advantages of the present invention will become apparent after a careful reading of the detailed description with appropriate reference to the accompanying drawings.

### BRIEF DESCRIPTION OF THE DRAWINGS

FIG. 1 is a side plan view in partial section of a pneumatic motor in accordance with the present invention;

FIG. 2 is an operational side plan view in partial section of the pneumatic motor in FIG. 1;

FIG. 3 is a side plan view in partial section of a conventional pneumatic motor in accordance with the prior art; and

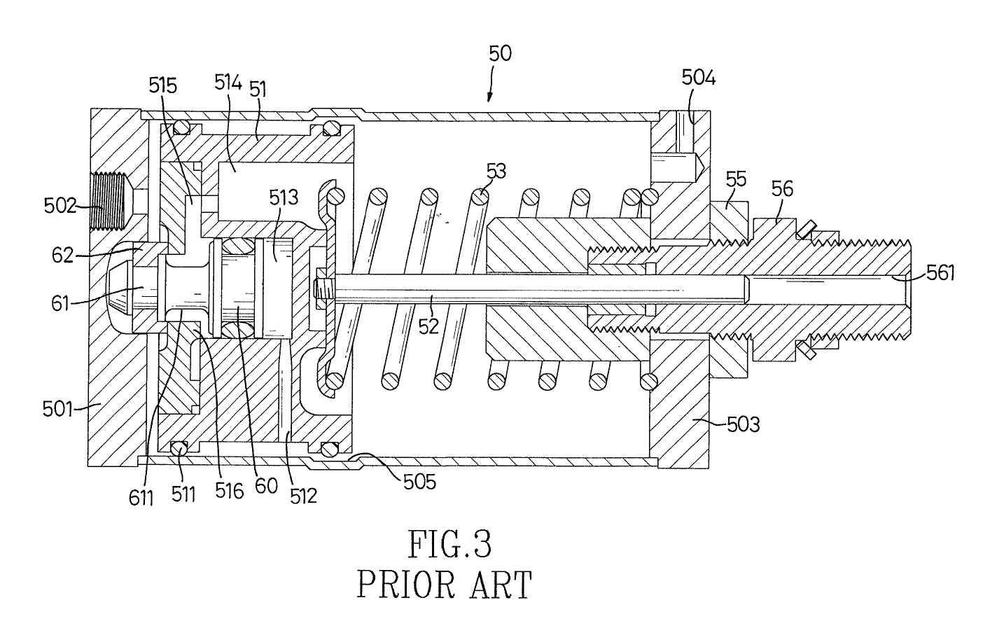

FIG. 4 is an operational side plan view in partial section of the conventional pneumatic motor in FIG. 3.

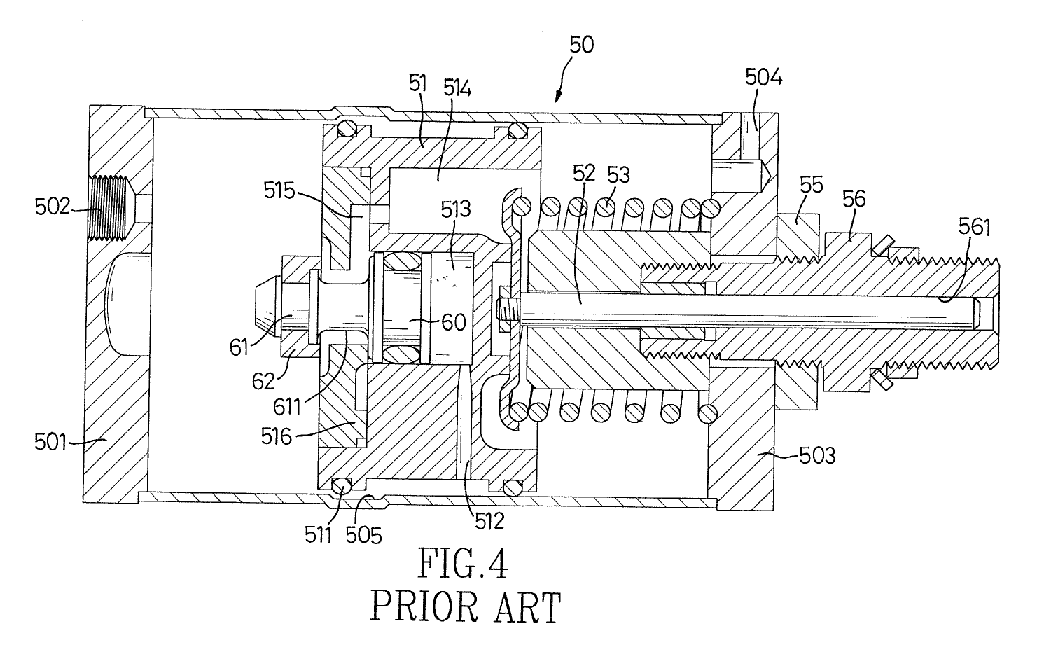

### DETAILED DESCRIPTION OF THE INVENTION

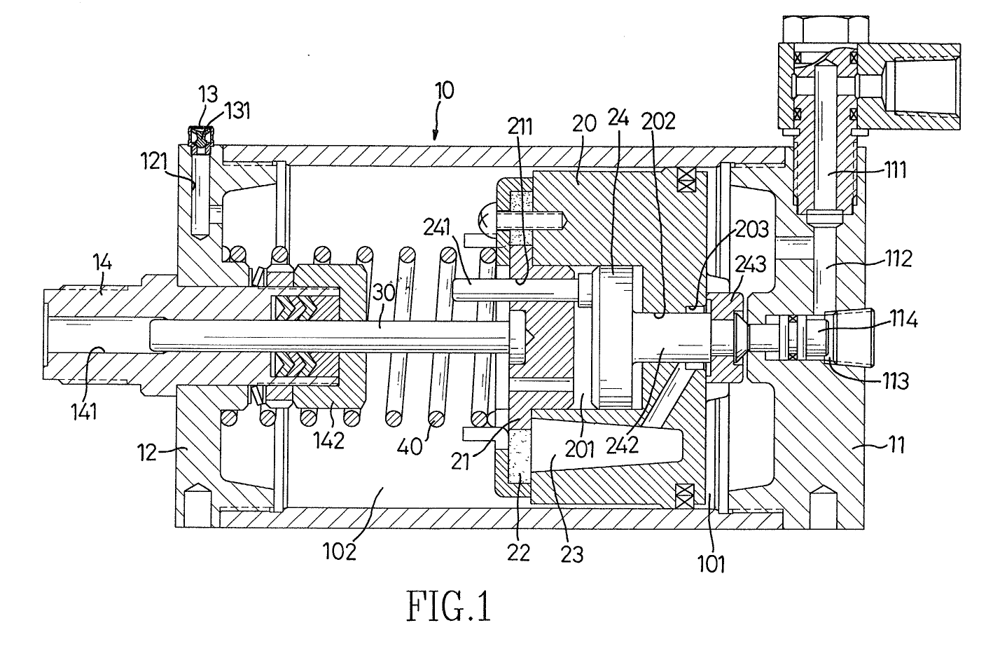

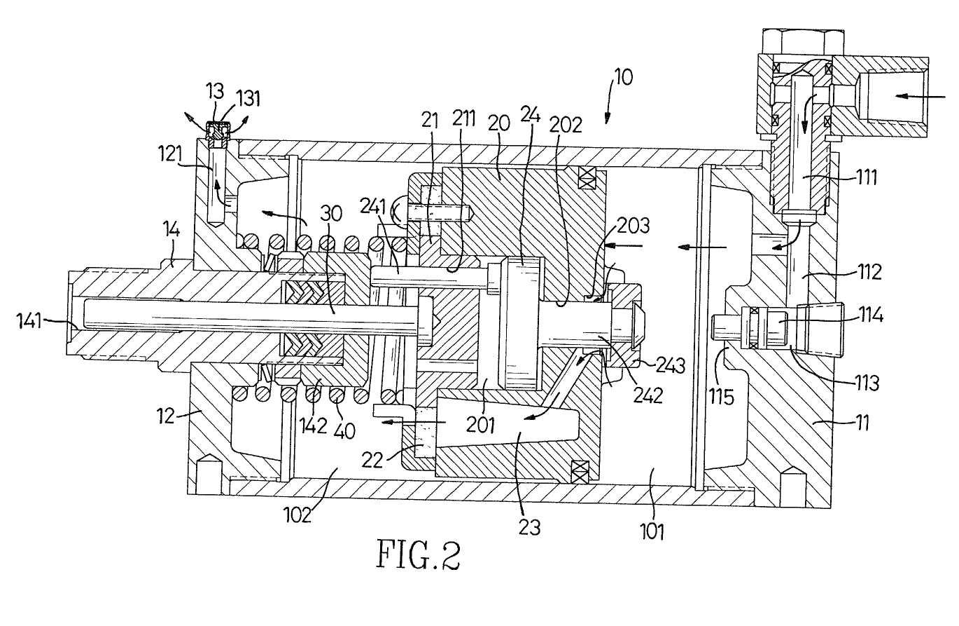

With reference to FIGS. 1 and 2, a pneumatic motor in accordance with the present invention comprises a cylinder (10), a piston (20) movably received in the cylinder (10) and a drive rod (30) secured on the piston (20).

The cylinder (10) includes a first end cover (11) and a second end cover (12) respectively mounted in and closing opposite ends of the cylinder (10). An inlet port (111) is defined in the first end cover (11), and a cavity (113) is defined to communicate with the inlet port (111) via a first path (112). A shock absorber (114) is movably mounted in the cavity (113) and partially extends into the first chamber (101). The cavity (113) has an annular shoulder (115) formed on the inner end of the cavity (113) to limit the shock absorber's (114) travel into the cylinder (10) when compressed air is injected into the cylinder (10).

An outlet port (121) is defined in the second end cover (12), and a rod base (14) is mounted in the second end cover (12). An exhaust valve (13) is mounted in the external end of the outlet port (121 ) to prevent dust from entering the cylinder (10). A first valve disk (131) is mounted in the exhaust valve (13) to selectively close the outlet port (121).

The rod base (14) has a through hole (141) defined to communicate with the interior of the cylinder (10). A pad (142) is attached to one end of the rod base (14) in the cylinder (10) and has a hole defined to correspond to the through hole (141) of the rod base (14).

The piston (20) divides the cylinder (10) into a first chamber (101) communicating with the inlet port (111) and a second chamber (102) communicating with the outlet port (121). A cylindrical cavity (201) is defined in the end of the piston (20) facing the second end cover (12), and a hole (202) is defined between the base of the cylindrical cavity (201) in the piston (20) and the first chamber (101). The hole (202) has a diameter smaller than that of the cavity (201) in the piston (20). An annular groove (203) is defined in the external end of the hole (202) in the piston (20). An exhaust passage (23) is defined in the piston (20) between the second chamber (102) and the annular groove (203). A noise silencer (22) is attached to the outlet end of the piston (20) on the end of the exhaust passage (23) to reduce the noise when the compressed air flows through the exhaust passage (23). A fixing block (21) is mounted on the outlet end of the piston (20) to close the cavity (201) of the piston (20). A through hole (211) is eccentrically defined in the fixing block (21). A spring (40) is compressively mounted around the rod base (14) between the second end cover (12) and the piston (20).

An actuating piston (24) is movably received in the cylindrical cavity (201) in the piston (20). The actuating piston (24) has a diameter lightly smaller than that of the cavity (201) of the piston (20). A rod (241) is attached eccentrically to the actuating piston (24) and extends into the second chamber (102) through the through hole (211) in the fixing block (21). A shaft (242) centrally extends from the actuating piston (24) and is movably received in the hole (202) of the piston (20). The free end of the shaft (242) extends through the piston (20), and a second valve disk (243) is mounted on the free end of the shaft (242) to close the exhaust passage (23).

In operation, compressed air is injected into the first chamber (101) and pushes the shock absorber (114) to abut the shoulder (115) and close the cavity (113) in the first end cover (11). The piston (20) is pushed relative to the cylinder (10) by the air pressure. The drive rod (30) moves into the through hole (141) in the rod base (14), and the spring (40) is compressed. When the piston (20) moves to the position where the rod (241) strikes the pad (142), the shaft (242) is moved toward the first end cover (11). The second valve disk (243) opens to allow the first chamber (101) to communicate with the second chamber (102) via the exhaust passage (23). Accordingly, the air in the first chamber (101) will directly flow into the second chamber (102) through the exhaust passage (23) and the air in the second chamber (102) will flow out of the cylinder (10) via the outlet port (121) when the first valve disk (131) in the exhaust valve (13) is pushed open by the air pressure. The pushing force provided by the air pressure on the piston (20) will reduce. The tension in the compressed spring (40) will move the piston (20) back toward the first end cover (11), and the drive rod (30) moves out of the through hole (141) in the rod base (14). When the second valve disk (243) strikes the shock absorber (114), the second valve disk (243) is pushed toward the piston (20) and closes the exhaust passage (23) between the first chamber (101) and the second chamber (102). Consequently, the compressed air pushes the piston (20) toward the second end cover (12) again. The shock absorber (114) will absorb the striking force of the shaft (242) because the compressed air continually pushes the shock absorber (114) via the path (112) in the first end cover (11).

Due to the reciprocating action of the piston (20), a suction force will be applied to the hydraulic source as the drive rod (30) moves out of the through hole (141), and a compression force will be applied to the hydraulic fluid in the through hole (141) as the drive rod (30) moves into the through hole (141). With the appropriate use of a series of valves, the hydraulic fluid can be pumped to a hydraulic device such as a power repairing kit, a hoisting jack, a hydraulic cylinder, a hydraulic jack or the like.

Although the invention has been explained in relation to its preferred embodiment, it is to be understood that many other possible modifications and variations can be made without departing from the spirit and scope of the invention as hereinafter claimed.

What is claimed is:

1. A pneumatic motor comprising:
a cylinder having a first end cover and a second end cover respectively mounted in opposite ends of the cylinder, an inlet port defined in the first end cover and an outlet port defined in the second end cover, a rod base mounted in the second end cover and having a through hole defined to communicate with an interior of the cylinder;
a piston movably received in the cylinder, and dividing the cylinder into a first chamber communicating with the inlet port and a second chamber communicating with the outlet port, a cylindrical cavity defined in the piston facing the second end cover, a hole defined in the piston to communicate with the first chamber and the cylindrical cavity in the piston, the hole in the piston having a diameter smaller than that of the cylindrical cavity in the piston, an annular groove defined around the hole in the piston and communicating with the first chamber of the cylinder, an exhaust passage defined in the piston and communicating with the second chamber and the annular groove, a fixing block mounted on an outlet end of the piston to close the cavity in the piston and having a through hole defined in the fixing block; and
an actuating piston movably received in the cavity of the piston and having a diameter slightly smaller than that of the cavity in the piston, a rod extending from the actuating piston and entering the second chamber through the through hole in the fixing block, a shaft extending from the actuating piston and entering the first chamber through the hole in the piston, a valve disk attached to one end of the shaft in the first chamber to selectively close the exhaust passage.

2. The pneumatic motor as claimed in claim 1, wherein the first end cover comprises a cavity defined to communicate with the inlet port via a path defined in the first end cover, a shock absorber movably mounted in the cavity of the first end cover and partially extending into the first chamber, the first end cover having a shoulder formed on an inner end of the cavity to limit the shock absorber movement into the first chamber.

3. The pneumatic motor as claimed in claim 1 further comprising a exhaust valve mounted in an external end of the outlet port, a valve disk mounted in the exhaust valve to selectively close the outlet port.

4. The pneumatic motor as claimed in claim 1, wherein the rod base comprises a pad attached to one end of the rod base in the cylinder and having a hole defined to correspond to the through hole of the rod base.

5. The pneumatic motor as claimed in claim 1, wherein the piston comprises a noise silencer attached to an outlet end of the piston and on an outlet end of the exhaust passage to reduce noise when the compressed air flows through the exhaust passage.
